(19) United States
(12) Patent Application Publication
(10) Pub. No.: US 2021/0081808 A1
(43) Pub. Date: Mar. 18, 2021

(54) SYSTEM AND METHOD TO INTEGRATE A DYNAMIC MODEL FOR AGENTS IN A SIMULATION ENVIRONMENT USING A DEEP KOOPMAN MODEL

(71) Applicant: Samsung Electronics Co., Ltd., Suwon-si (KR)

(72) Inventor: Elena Ramona STEFANESCU, Sunnyvale, CA (US)

(21) Appl. No.: 16/655,219

(22) Filed: Oct. 16, 2019

Related U.S. Application Data
(60) Provisional application No. 62/902,383, filed on Sep. 18, 2019.

(51) Int. Cl. G06N 5/00; B60W 50/02; B60W 50/04; F02D 41/14; G06N 7/00

(52) U.S. Cl. CPC G06N 5/003; B60W 50/0205; F02D 2041/1437; F02D 41/1405; G06N 7/00; B60W 50/045

(57) ABSTRACT

A system for use in a simulation is disclosed. The system may comprise a receiver to receive states of the simulation. A memory may store sets of hyperparameters for a neural network encoder. The memory may also store A-matrices. The neural network encoder, implemented using a processor, may use hyperparameters to implement an encoding function. The hyperparameters and an A-matrix may be selected from the memory responsive to the states of the simulation. The A-matrix may be used to determine a next predicted state for the simulation.

### RELATED APPLICATION DATA

This application claims the benefit of U.S. Provisional Patent Application Ser. No. 62/902,383, filed Sep. 18, 2019, which is incorporated by reference herein for all purposes.

This application is related to U.S. patent application Ser. No. 16/576,750, filed Sep. 19, 2019, which claims the benefit of U.S. Provisional Patent Application Ser. No. 62/889,033, filed Aug. 19, 2019, both of which are incorporated by reference herein for all purposes.

### FIELD

The inventive concepts relate generally to simulations, and more particularly to simulations involving autonomous vehicles.

### BACKGROUND

In order to analyze, control, and predict the evolution of dynamical systems, the governing equations of such dynamical systems must be understood. For many complex systems of interest, the exact governing equations are either unknown or are prohibitively expensive to accurately evaluate. For example, these governing equations may involve non-linear differential equations that are difficult or impossible to solve mathematically and expensive to solve computationally (given the number of computations that need to be executed).

For the purpose of traffic simulations, where a large number of vehicles, pedestrians, cyclists and other elements of the road network are simulated, implementing a highly complex dynamic model would greatly affect the performance of the simulation. The complexity of the vehicle model would entail a higher computation time of the system, making it unsuitable for any real time application.

A need remains to provide for to simplify the solution to such complex systems.

### BRIEF DESCRIPTION OF THE DRAWINGS

FIG. 1 shows a processor using a neural network encoder and Koopman theory to convolve a non-linear dynamical system into a linear system, according to an embodiment of the inventive concept.

FIG. 2 shows details of a machine including the processor of FIG. 1.

FIG. 3 illustrates a simplified motion control block diagram.

FIG. 4 illustrates the use of a deep Koopman model for dynamical models using the neural network encoder of FIG. 1.

FIG. 5 shows a deep learning schema using the neural network encoder of FIG. 1.

FIG. 6 shows a linear Koopman model using the neural network encoder of FIG. 1.

FIG. 7 shows approximating a curve using straight line segments.

FIG. 8 shows various tables of information stored in the memory of FIG. 1.

FIG. 9 shows a flowchart of an example procedure to use the neural network encoder of FIG. 1 and Koopman theory to simplify the solution to a complex system, according to an embodiment of the inventive concept.

FIG. 10 shows a flowchart of an example procedure to use the neural network encoder of FIG. 1 and the neural network decoder of FIG. 1 in determining hyperparameters for the neural network encoder of FIG. 1, according to an embodiment of the inventive concept.

### DETAILED DESCRIPTION

Reference will now be made in detail to embodiments of the inventive concept, examples of which are illustrated in the accompanying drawings. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the inventive concept.

The terminology used in the description of the inventive concept herein is for the purpose of describing particular embodiments only and is not intended to be limiting of the inventive concept. As used in the description of the inventive concept and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Koopman theory offers an alternative viewpoint through which non-linear dynamics can be mapped to linear dynamics. Koopman theory states that there is a linear predictor for a non-linear dynamical system which is faster to compute. By predictor is meant an artificial dynamical system that can predict the future states (or output) of a given non-linear dynamical system based on the measurement of the current state (or output) and current and future inputs of the system.

Dynamic agents within a simulator are required to behave as realistic as possible for extensive and exhaustive testing of the System Under Test (SUT). Due to the complexity of the governing equation, many simulators on the market are using approximative, linearized models that pose difficulty in matching a real agent driving in a complex situations.

The basic idea is to transform the state space of the non-linear system (vehicle, pedestrian, cyclist, etc.) to a higher-dimensional space, where the system dynamics is linear. The mapping in the higher-dimensional space can be done using other basis functions or a neural network. One advantage of using a neural network approach is its relative simplicity, as the neural network architecture is equivalent to that of a standard auto-encoder.

The study of the dynamical systems (e.g., vehicle, pedestrians, cyclists, etc.) in much of the last century has been dominated by the model-based state-space approach. In this approach, one first constructs a model for the evolving system based in physical laws and/or observations, and then analyzes the geometry of trajectories in the state space. This viewpoint has contributed a lot to our understanding of dynamical systems and the modern control theory, but it is falling short in treating many systems of current interest like self-driving cars. This shortcoming is due to the high-dimensionality and uncertainty in models of such systems which prohibits the applications of the classical techniques.

In a simulation environment that needs to be capable to simulate a wide range of complex situations (complex interaction between dynamic agents and their environment), the computation intensive numerical models for the dynamic agents can be a limitation in scaling of the framework. The exact form of a dynamic model has strong implications for how easily the model can be incorporated into a control or planning framework.

The procedure to construct Koopman linear predictors is data-driven. It boils down to a non-linear transformation of the data (the lifting) and a linear least-squares problem in the lifted space that can be readily solved for large data sets. A deep Koopman model is a method for inferring distributions over Koopman observations that can be propagated linearly in time. The model requires the training of a single neural network model, enabling the sampling of an ensemble of linear dynamics models in the space of observations. Together, this model ensemble effectively provides a distribution over the system dynamics, which can be easily integrated with an existing control framework.

The main focus of this application is to provide an innovative way to deal with complex Vehicle Dynamic Models that are coupled with the controller with the goal to follow a given trajectory for multiple interacting dynamic agents in a simulation environment. The Vehicle Dynamic Model states evolve accordingly to a highly non-linear map or differential equation.

Traditionally, when the dynamics are highly non-linear this problem has been solved by either linearizing around the current state space or allocating massive computational resources for timely calculation of the vector space. But instead of attempting to maintain the same state space or apply intense computation resources (and without attempting to hybridize multiple different models, as described in related co-pending U.S. patent application Ser. No. 16/576,750, filed Sep. 19, 2019, which claims the benefit of U.S. Provisional Patent Application Ser. No. 62/889,033, filed Aug. 19, 2019, both of which are incorporated by reference herein for all purposes), a Deep Koopman operator may be used to “lift” the state-space into a higher dimensional space, where the evolution of this lifted state is (approximately) linear, resulting in fast and accurate estimation of the states.

In a mathematical formulation, consider a non-linear discrete-time dynamical system described by:

xₜ₊₁=F(xₜ)
where F is a non-linear operator that evolves the current state xₜϵ [symbol] ⁿ to the next time step xₜ₊₁. Let the Koopman operator K be an infinite-dimensional linear operator that acts on all observable functions g: [symbol] ⁿ→ [symbol] . Koopman theory asserts that a non-linear discrete-time system may be mapped to a linear discrete-time system, where the Koopman operator advances observations of the state forward in time:

Kg(xₜ)=g(F(xₜ))=g(xₜ₊₁)

For a finite number of observable functions {g₁, . . . gₘ} that span a subspace G such that Kgϵg for any g E G, then G is considered to be an invariant subspace and the Koopman operator becomes a finite-dimensional operator. If the vector-value observable is defined as g=[g₁, . . . , gₘ} and the matrices \tilde{X}=[g(x₁), g(x₂), . . . , g(x_{T})] and \tilde{Y}=[g(x₂), g(3), . . . , g(x_{T+1})], then the matrix A=\tilde{Y}\tilde{X}* (where the * operator indicates the conjugate transpose operator) will asymptotically approach the Koopman operator K with increasing T. (Note that the states are indexed here starting at x₁, but any index may be used: for example, the first state may also be denoted as x₀.) The task of finding the set of observables that span an invariant subspace can be reduced to finding a state mapping g(xₜ) under which linear least-squares regression is thereby minimized. The mapping can be performed using deep neural networks.

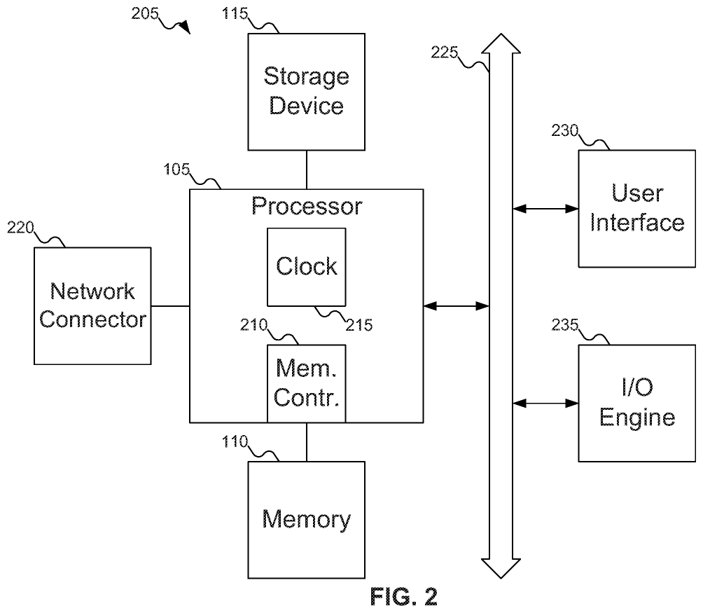

To construct the matrices X and Y a sequence of time snapshots x_{1:T+1} may be used. These matrices may be fed into a neural network encoder, which serves as the mapping g(xₜ) and produces the matrices \tilde{X} and \tilde{Y} (note that while X and Y appear above as vectors, each of the components g(xᵢ) are themselves vectors representing individual states at different times in the simulation: thus \tilde{X} and \tilde{Y} are actually matrices). A linear least-squares fit is performed to find an A-matrix that can propagate the state mapping forward in time. X and the propagated state mappings are fed into a decoder that functions as g⁻¹ to yield the matrices X and Y, approximations to X and Y, as seen in FIG. 2.

The Koopman operator may be coupled with Deep Learning (DL) techniques powered by Neural Networks for a data-driven model. The Neural Network may be based on a deep auto-encoder, which is able to identify a mapping g, such that y=g(x) and decode these coordinates to recover x=g⁻¹(y). Each hidden layer has the form of Wx+b, followed by an activation with the rectified linear unit (ReLU): f (x)=max{0, x}. (W represents a weight and b represents a bias: since x is a vector, W may be a constant and b may be a vector.) The encoder may consist of ResNet convolutional layers with ReLU activations followed by fully connected layers, while the decoder inverts all operations performed by the encoder. ResNet architecture was built on the foundation of a classical network architecture, comprised of new and innovative way of stacked convolutional layers. According to the universal approximation theorem, given enough capacity, a feedforward network with a single layer is sufficient to represent any function. However, the layer might be massive and the network is prone to overfitting the data. Deep residual networks are a breakthrough idea which enable the development of much deeper networks (hundreds of layers as opposed to tens of layers). This architecture serves as rich feature extraction which can be used for image classification, object detection, image segmentation as well linear embeddings of non-linear dynamics.

To differentiate between the above mentioned applications, the definition of the loss function is a key component. An embodiment of a loss function has three weighted mean-squared error components: reconstruction accuracy L_{recon}, future state prediction L_{pred}, and linearity of dynamics Lₗᵢₙ. Since it may be assumed that there are no outliers in our data, an L_{∞} term to may be used to penalize the data point with the largest loss. An l₂ regularization on the weights W can be added to avoid overfitting.

Optimization may be performed using a first-order gradient descent with batch normalization imposed on the inputs of hidden layers.

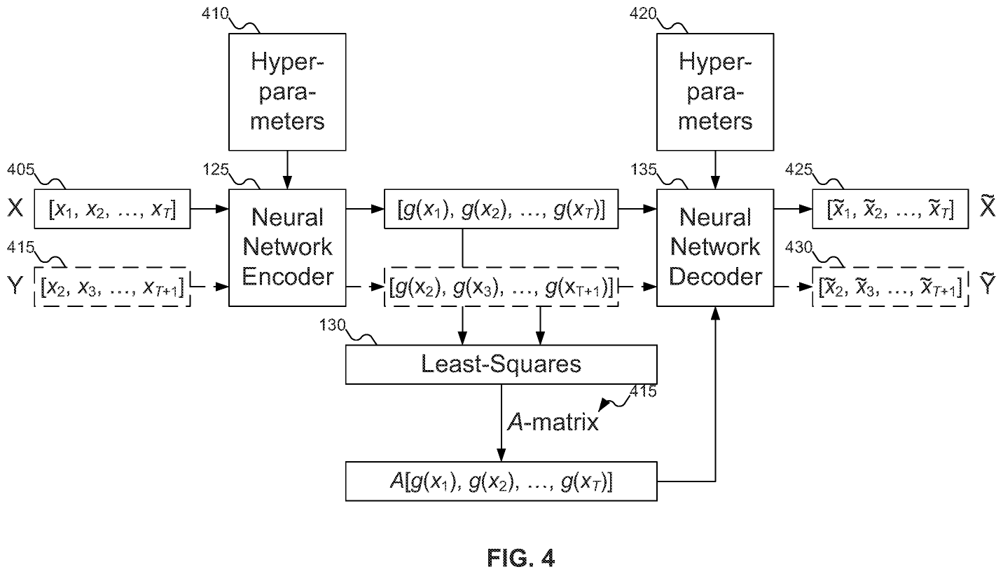

Reconstruction accuracy of the auto-encoder may achieved using the following loss: L_{recon}=∥x−g⁻¹(g(x))∥. Linear dynamics A may advance the intrinsic variables y forward in time: g(xₖ₊₁)=Ag(xₖ), which is equivalent with yₖ₊₁=Ayₖ. Linear dynamics are achieved using the following loss: ∥g(xₖ₊₁)−Ag(xₖ)∥. More generally, linear prediction over T time steps ay be enforced with the loss: Lₗᵢₙ=∥g(x_{2:T+1})−A^{1:T} g(x_{1:T})∥. This is equivalent with solving a least-square problem, where the data lies on a linear manifold. Finally, the linear dynamics identified in the matrix A must enable future state prediction (as seen in FIG. 4). This may be translated in the following loss: L_{pred}=∥xₖ₊₁−g⁻¹(Ag(xₖ))∥.

The total cost function has the following form: L=α₁(L_{recon}+L_{pred})+Lₗᵢₙ+α₂L_{∞}+α₃∥W∥₂, where weights α₁, α₂, and α₃ are hyperparameters. Each weight matrix W may be initialized randomly from a uniform distribution in the range [−s, s] for

$$s = \frac{1}{\sqrt{a}} ,$$

where α is the dimension of the input layer. Each bias vector b may be initialized to 0.

The training dataset may be constructed by saving snapshots of the system over a scenario (e.g., highway driving, left turn in an intersection, roundabout, etc.) using any simulation engine (e.g., Car Learning to Act (CARLA)). For each image a velocity, throttle, and breaking control value may be associated, among other variables.

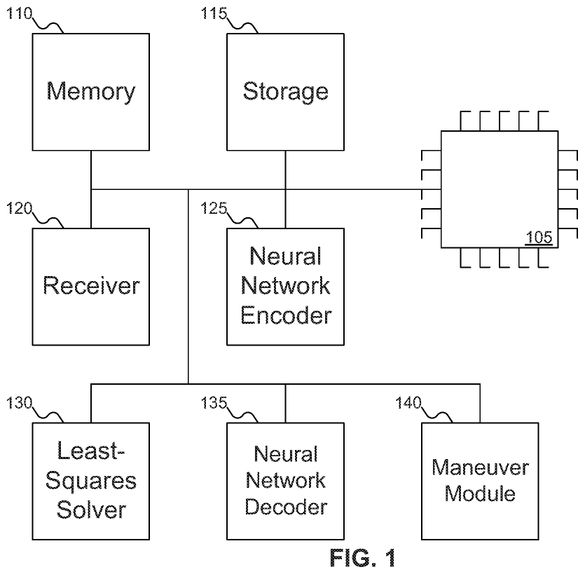

FIG. 1 shows a processor using a neural network encoder and Koopman theory to convolve a non-linear dynamical system into a linear system, according to an embodiment of the inventive concept. In FIG. 1, the simulation may be implemented as software running on processor 105, which may be, among other possibilities, a general purpose central processing unit (CPU). Alternatively, the simulation may be implemented using firmware stored on another chip (not shown in FIG. 1) or may be implemented using hardware, such as a Field Programmable Gate Array (FPGA), Application-Specific Integrated Circuit (ASIC), a Graphics Processing Unit (GPU), or other hardware.

Processor 105 may be implemented in various constructs, such as within a computer system, within a vehicle (if the vehicle is autonomous), or with any other use of a simulation. Any reference in this document to “machine” is intended to represent any physical implementation of embodiments of the inventive concept, including (but not limited to) a computer implementation or within an autonomous vehicle. This computer system (or machine) may include processor 105. Processor 105 may be any variety of processor: for example, an Intel Xeon, Celeron, Itanium, or Atom processor, an AMD Opteron processor, an ARM processor, etc. While FIG. 1 shows a single processor 105, the machine may include any number of processors, each of which may be single core or multi-core processors, and may be mixed in any desired combination. The machine may also include other hardware and/or software components not shown in FIG. 1, such as input/output devices and an operating system.

Processor 105 may be coupled to memory 110. Memory 110 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 110 may also be any desired combination of different memory types, and may be managed by a memory controller (not shown in FIG. 1). Memory 110 may be used to store data that may be termed “short-term”: that is, data not expected to be stored for extended periods of time. Examples of short-term data may include temporary files, data being used locally by applications (which may have been copied from other storage locations), and the like.

Processor 105 and memory 110 may also support an operating system under which various applications may be running. These applications may issue requests to read data from or write data to storage 115, which may be the memory or other storage, such as a hard disk drive or Solid State Drive (SSD). Storage 115 may be used, for example, to store initial parameters (or ranges of values for initial parameters, along with what types of behaviors the ranges of values represent) used to initialize the simulation.

Receiver 120 may be used to receive information about the state of the simulation, which may be provided to processor 105. That is, receiver 120 may receive information about the location, orientation, and velocity of the agent being simulated, as well as information about other agents and elements of the simulation. For example, if the simulation involves a vehicle, receiver 120 may receive information about the location, orientation, and velocity of other agents in the simulation, as well as the location and identity of other objects in the simulation (such as signs, lights, and other agent instructions).

Neural network encoder 125, which may be implemented as software being executed by processor 105, may be used to provide an encoding that maps a state in [symbol] ⁿ to a state in [symbol] ^{m}, where m is greater than n. As discussed above, Koopman theory provides that a non-linear problem may be convolved into a linear problem in a higher dimension space. Thus, while the problem posed by a complex system may be involve non-linear equations in [symbol] ⁿ, by “lifting” the state from [symbol] ⁿ to [symbol] ^{m} the problem may now involve linear equations that may be solved more easily and faster, without accuracy loss. Then, by reversing the encoding implemented to lift the state from [symbol] ⁿ to [symbol] ^{m}, the appropriate state in the original dimension may be determined (if needed or desired). Neural network encoder 125 may implement a function g(x) that “lifts” the state from [symbol] ⁿ to [symbol] ^{m}.

Once the state has been “lifted” to [symbol] ^{m}, least-squares solver 130 may be used to determine a solution to the linear problem in [symbol] ^{m} that minimizes the overall loss of the problem. Specifically, least-squares solver 130 may determine a matrix A that best determines the next state of the simulation in [symbol] ^{m}. Since the non-linear problem in [symbol] ⁿ has been mapped to a linear problem in [symbol] ^{m}, the determination of matrix A and its use are much simpler than the solution to the non-linear problem in [symbol] ⁿ.

While FIG. 1 shows least-squares solver 130 as being used to determine the matrix A that best determines the next state of the simulation in [symbol] ^{m}, other linear regression techniques may be used in place of least-squares solver 130. For example, least trimmed squares, linear regression, polynomial regression, ridge regression, lasso regression, and ElasticNet regression may all be used instead of least-squares solver 130, as may other linear regression techniques not specifically named herein.

Since the A-matrix solves the problem in [symbol] ^{m}, the solution is not necessarily known in the original state space (in [symbol] ⁿ). But it may not be necessary to determine the actual state in the original state space. For example, if the objective of the simulation is simply to determine an appropriate action (or maneuver) to perform based on the current state of the simulation, it may be possible to determine that maneuver in [symbol] ^{m} alone. For example, if the simulation is for an agent in an autonomous vehicle simulation, it may be sufficient to determine whether the vehicle should simply maintain its current heading and velocity or make some changes to its heading or velocity: these data may be determined based on the information in [symbol] ^{m} without first mapping the state back to [symbol] ⁿ. (Note that the simulation does not necessarily need to know the next predicted state: the next actual state may be input to the system via receiver 120 at the next point in time.) But if it is desired to map the state back to [symbol] ⁿ—for example, to double-check that the simulation is not erring too greatly in its computations, or as part of training neural network encoder 125—neural network decoder 135 may be used to devolve the state from [symbol] ^{m} back to [symbol] ⁿ using a function g⁻¹(x) (the inverse of the encoding function implemented using neural network encoder 125).

Finally, maneuver module 140, which may be implemented as software being executed by processor 105, may be used to determine the appropriate maneuver to perform to move from the current actual state to the next predicted state. For example, if the agent is a vehicle in a vehicle simulation, maneuver module 140 may determine an appropriate change in heading or velocity (that is, to accelerate or decelerate) for the vehicle. Maneuver module 140 is discussed further with reference to FIG. 4 below.

As hinted above, it is important to bear in mind the difference between the actual state of the simulation and the predicted state of the simulation. The actual state of the simulation is the state of the simulation as received as input via receiver 120 and/or other input devices. The predicted state of the simulation, on the other hand, is the state the simulator is predicted to be based on previous input. While in an ideal world a predicted state of the simulation becomes the next actual state of the simulation, the real world is not ideal. Deltas may be introduced in either the encoding or decoding operations, as neither operation is necessarily perfect. Further, while least-squares solver 130 attempts to find the A-matrix that is the best fit solution for the available data, the best fit may not be a perfect fit, and the application of the A-matrix may also introduce deltas. Thus, for any given time i, there may be a difference between (actual state) x₁ and (predicted state) \tilde{x}ᵢ.

FIG. 2 shows details of a machine including the processor of FIG. 1. In FIG. 2, typically, machine 205 includes one or more processors 105, which may include memory controllers 210 and clocks 215, which may be used to coordinate the operations of the components of the machine. Processors 105 may also be coupled to memories 110, which may include random access memory (RAM), read-only memory (ROM), or other state preserving media, as examples. Processors 105 may also be coupled to storage devices 115, and to network connector 220, which may be, for example, an Ethernet connector or a wireless connector. Processors 105 may also be connected to buses 225, to which may be attached user interfaces 230 and Input/Output interface ports that may be managed using Input/Output engines 235, among other components.

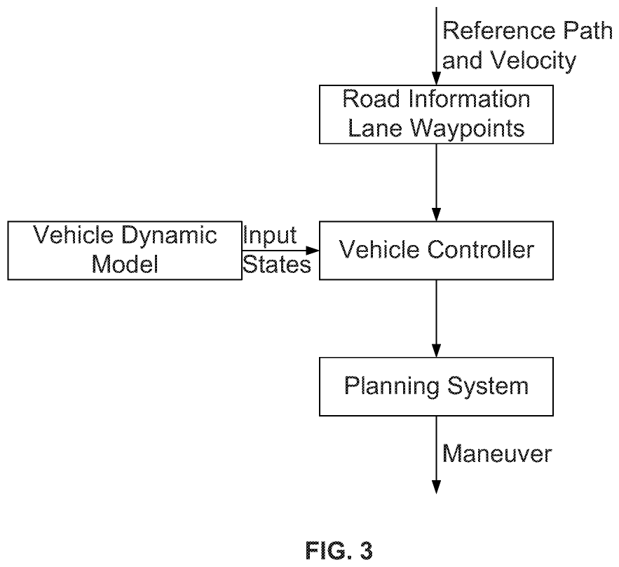

FIG. 3 illustrates a simplified motion control block diagram. In FIG. 3, a dynamic agent (such as a vehicle, a cyclist, or a pedestrian) may navigate within a given environment. The main components of such an agent are: Vehicle Dynamic Model, Control, and Planning Modules. The System Under Test (SUT) differentiates from the other dynamic agents by using additional modules such as Localization, Maps, and Perception. The Vehicle Dynamic Model provides input states regarding the agent: information such as location, orientation, velocity (given that the mathematical definition of velocity includes both speed and heading, orientation (another term for heading) may be considered part of velocity and not necessarily provided as a separate component), minimum and maximum speeds, minimum and maximum acceleration/deceleration, etc. Combined with information about road information and waypoints, the Vehicle Controller may determine a plan for future agent performance. For example, the Vehicle Controller may determine that the agent needs to slow down for an upcoming stop sign. The Planning System may then map this plan into a maneuver for the agent: for example, whether it is time to begin decelerating and if so how quickly to decelerate.

FIG. 4 illustrates the use of a deep Koopman model for dynamical models using neural network encoder 125 of FIG. 1. In FIG. 4, neural network encoder 125 is used in conjunction with least-squares solver 130 to take advantage of Koopman theory: the (non-linear) problem posed by solving the system in its original state is “lifted” into a higher dimension where the problem become a linear problem. An A-matrix may then be used to simply solve the (linear) problem and predict the next state of the simulation, from which a maneuver may be derived for the agent.

Recall that xᵢ represents the state of the simulation at time i. Thus, at the current time T, x_{T} represents the current state of the simulation, with states x₁ through x_{T-1} representing the previous states of the simulation. All of this information may be provided to neural network encoder 125 as matrix X (matrix 405). In conjunction with hyperparameters 410 (discussed below), neural network encoder 125 may then implement an encoding function g(x) that “lifts” a state vector xᵢ from [symbol] ⁿ to [symbol] ^{m}. (Note that while in most cases it is expected that the problem will be simpler to solve in a higher dimension by virtue of Koopman theory—a non-linear problem may be be replaced with a linear problem—there is no reason why the encoding function g(x) may not move a state vector xᵢ into a lower dimension, if the problem may be easily solved in such a lower dimension. Thus, while m may be larger than n in general, such is not a requirement of the system.) Thus, given matrix X 405 which includes states [x₁, x₂, . . . , x_{T}], neural network encoder 125 may implement encoder function g(x) to produce “lifted” states [g(x₁), g(x₂), . . . , g(x_{T})]. (Recall that each state is a vector in [symbol] ⁿ, whereas encoder function g(x) produces a vector in [symbol] ^{m}. Thus while the number of vectors is not changed, the number of components in each vector is modified by encoding function g(x).)

Notice that neural network encoder 125 receives not just the current state vector x_{T}, but earlier state vectors as well. This may be helpful, as knowing how the simulation reached the current state may be useful in determining the appropriate state moving forward. Consider, for example, the situation where an agent has been operating at a constant velocity for some interval of time. Now, in the current state, something has changed suddenly: for example, perhaps another vehicle suddenly changed lanes to the agent's current lane without any warning. Knowing that the other vehicle was not currently in the agent's lane may be pertinent to how the agent responds: rather than coming to a complete stop or taking a drastic evasive maneuver (by concluding that the other vehicle is a fixed obstacle), the agent might just decelerate slightly to increase the distance from the other vehicle (by knowing that the other vehicle was previously in an adjacent lane).

But the fact that neural network encoder 125 receives all this additional information also means that the encoding function implemented by neural network encoder 125 may vary based on the input. In other words, the encoding function g(x) used at time 1 may not be the appropriate encoding function g(x) to use at time T. Neural network encoder 125 does not need to be replaced with a different neural network encoder: neural network encoder 125 should know how to process all inputs appropriately. But the encoding function g(x) may be varied by adjusting hyperparameters 410.

Hyperparameters 410 are other inputs to neural network encoder 125 that may vary how neural network encoder 125 processes the other input data (that is, states x₀ through x_{T}) by varying the weights and biases used by neural network encoder 125. To understand this, a review of how neural network encoder 125 operates is helpful.

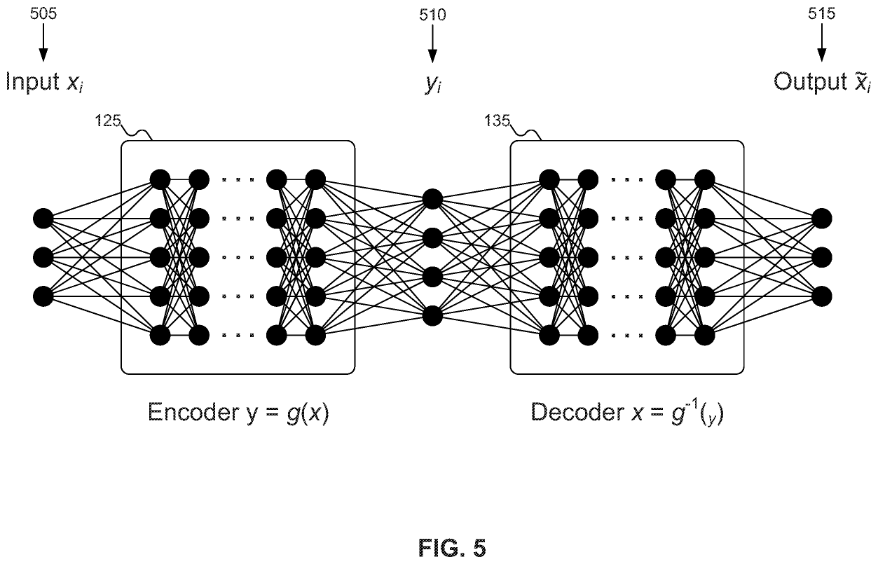

Looking ahead briefly to FIG. 5, neural network encoder 125 may be seen as including nodes arranged in layers. Each node receives input from the nodes in the previous layer and provides output to the nodes in the subsequent layer: the first layer of nodes receives input state xᵢ 505, and the last layer of nodes provides output state yᵢ 510 of neural network encoder 125. Note that the number of components in output state yᵢ is greater than the number of components in input state xᵢ: this fact represents that the encoding function g(x) “lifts” the input state xᵢ from [symbol] ⁿ to [symbol] ^{m}.

Because each node receives information from all the nodes in the previous layer, each node may be thought of as executing a function of the form Wx+b, where W is a constant (called a weight) applied to that node, and b is a vector (called a bias) applied to that node. By changing the value of W and the vector b, the computation performed by that node may be adjusted. Doing such adjustments for even one node (and certainly for all nodes) in neural network encoder 125 may change encoding function g(x). The values of W and b for each node are, among others, hyperparameters 410 of FIG. 4. Thus, if appropriate hyperparameters 410 of FIG. 4 are known for a given set of states, it is possible to appropriately adjust the encoding function performed by neural network encoder 125.

Returning to FIG. 4, then, by varying hyperparameters 410 different encoding functions g(x) may be implemented. Given the training used to originally define neural network encoder 125, different hyperparameters 410 may be identified for different input sets. Thus, for example, given an input of just state xᵢ, one set of hyperparameters 410 may be determined, given an input of states x₁ and x₂, another set of hyperparameters 410 may be determined, and so on.

In an ideal world, the inputs to neural network encoder 125 would include every state since the start of the simulation. But such an implementation requires an ever-increasing amount of storage as more time passes and more states are encountered. Thus, using every state starting from x₁ in all cases may not be practical. In addition, as time progresses, older information becomes less meaningful: events that happened five hours ago may not necessarily be pertinent to the current state of the simulation. This is not to say that older events have no relevance at all: for example, if a vehicle has traveled more than 300 miles since it was last refueled, it may well be time to refuel the vehicle. On the other hand, the fact that the vehicle came to a stop at a stop sign 300 miles back is of almost no significance to the current operation of the vehicle. Thus, instead of storing and using information about all states since state xᵢ, some embodiments of the inventive concept may set a cap on the number of states stored and only retain the most current k states, with older states being discarded. That is, if the current time is time T, then matrix X 405 may include only states [x_{T-k}, x_{T-k+1}, . . . , x_{T}].

Once “lifted” states [g(x₁), g(x₂), . . . , g(x_{T})] are determined by neural network encoder 125, they may be provided to least-squares solver 130. Recall that by “lifting” the states into a higher dimension, the original (non-linear) problem has been reduced to a linear problem, for which a least-squares solution may be possible. By using A-matrix 415 appropriate to encoding function g(x), a simple solution may be determined, calculated as A[g(x₁), g(x₂), . . . , g(x_{T})]. From this information, an appropriate maneuver may be determined based on the current state x_{T} (and the previous states x₁ through x_{T-1}). (Note that the size of the A-matrix may vary with the number of “lifted” states: a larger A-matrix may be used when more “lifted” states are included than when fewer “lifted” states are included.)

Recall that the general problem to be solved is to determine state x_{T+1}=F(x_{T}), and that Koopman theory asserts that Ag(xᵢ)=g(F(xᵢ))=g(xᵢ₊₁). Put in words, A-matrix 415 may operate as a linear predictor for the next state xᵢ₊₁ under encoding function g(x). Thus, if g(xᵢ₊₁) may be determined, and assuming that an inverse for the encoding function g(x) may be determined (which may be represented as g⁻¹(x)), then the next predicted state for time T may be determined based on the fact that x_{T+1}=g⁻¹(g(x_{T+1}))=g⁻¹(Ag(x_{T})). Note that since g(x) and g⁻¹(x) are intended to be inverse functions (that is, ideally g⁻¹(g(x))=g(g⁻¹(x))=x), hyperparameters 420 should be derivable from hyperparameters 410: if a node in neural network encoder 125 implements the equation Wx+b, then the corresponding node in neural network decoder 135 may implement the equation

$$\frac{1}{W} ( x - b ) = \frac{1}{W} x - \frac{1}{W} b$$

to reverse the computation.

At this point, the process of determining A-matrix 415 may be described. A-matrix 415 may be determined as the result of performing a least-squares solution (that is, minimizing the loss) to the equation Lₗᵢₙ=∥g(xᵢ₊₁)−Ag(xᵢ)∥ (which may also be expressed as Lₗᵢₙ=|yᵢ₊₁−Ayᵢ∥). Put another way, A-matrix 415 may be selected as a matrix that produces the minimum variation between the actual next state in the “lifted” state space and the predicted next state in the “lifted” state space.

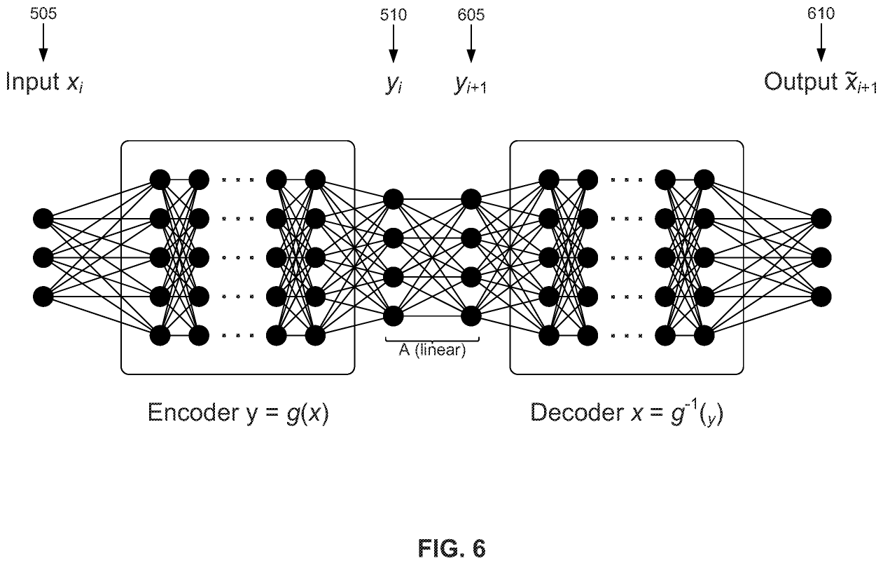

FIG. 6 shows everything put together. In FIG. 6, neural network 125 may be provided input state xᵢ 505 and output state yᵢ 510. By applying the appropriate A-matrix, output state yᵢ 510 may be mapped to a next predicted state yᵢ₊₁ 605. By applying decoder function g⁻¹(x) as implemented by neural network decoder 135, next predicted state \tilde{x}ᵢ₊₁ may be determined (\tilde{x}ᵢ₊₁, of course, being the next predicted state in the original state space rather than the “lifted” state space).

A comparison of FIGS. 5 and 6 shows that they are very similar, except that FIG. 6 also applies A-matrix 415 of FIG. 4. This fact might lead to the question of the purpose of FIG. 5. In fact, FIG. 5 aside from showing the use of neural network encoder 125 and neural network decoder 135 in isolation from A-matrix 415 of FIG. 4, FIG. 5 may be used in training neural network encoder 125 (and neural network decoder 135). That is, during training of neural network encoder 125 hyperparameters 410 of FIG. 4 may be varied to determine the encoding that minimizes the loss imposed by encoding and decoding (mathematically, minimizing the loss L_{recon}=∥x−g⁻¹(g(x))∥) while still “lifting” the original state xᵢ to state yᵢ in a dimension where the problem is linear rather than non-linear.

A careful reader may note that in FIG. 5 original input state 505 is denoted as xᵢ, whereas output 515 of neural network decoder 135 is denoted as \tilde{x}ᵢ: similarly, in FIG. 6, output 610 of neural network decoder 135 is denoted as \tilde{x}ᵢ₊₁. This change in notation represents the fact that neither neural network encoder 125 nor neural network decoder 135 may work perfectly. Ideally xᵢ=\tilde{x}ᵢ, but because neural network encoder 125 and neural network decoder 135 may not operate ideally, either neural network might introduce deltas. Thus, to represent the fact that the process of encoding and decoding may not be ideal, the output of the combination of neural network encoder 125 and neural network decoder 135 is represented as \tilde{x}ᵢ.

Returning to FIG. 4, just as encoding function g(x) implemented by neural network encoder 125 may be determined by hyperparameters 410, hyperparameters 420 may be determined that may define decoding function g⁻¹(x) that may be implemented by neural network decoder 135. As with hyperparameters 410, hyperparameters 420 used to define the decoding function of neural network decoder 135 may be identified by using matrix X 405. By applying decoding function g⁻¹(x) to “lifted” states [g(x₁), g(x₂), . . . , g(x_{T})], matrix \tilde{X} 425 may be determined with “dropped” states [\tilde{x}₁, \tilde{x}₂, . . . , \tilde{x}_{T}] (which, again, ideally would match matrix X 405).

Finally, FIG. 4 also shows (with dashed lines) matrix Y 415 including states [x₂, x₃, . . . , x_{T-1}], which may be mapped by neural network encoder 125 to states [g(x₂), g(x₃), . . . , g(x_{T+1}), and which may be mapped by neural network decoder 135 to states [\tilde{x}₂, \tilde{x}₃, . . . , \tilde{x}_{T+1}] in matrix \tilde{Y} 430. The dashed lines are used to represent that these elements are optional. Obviously, if matrix X 405 includes states x₂, x₃, . . . , x_{T}, these states do not need to be provided as part of matrix Y 415 (since the purpose of the model shown in FIG. 4 is to determine next predicted state \tilde{x}_{T+1}, \tilde{x}_{T+1} may not be known to include in matrix Y 415). But similar to the discussion about the use of neural network decoder 135 with reference to FIG. 5, these elements may be used in training neural network encoder 125. That is, given both the predicted and actual states, the difference between those pairs of states may be used in training neural network encoder 125 (and to determine hyperparameters 410, as well as training neural network decoder 135 and determining hyperparameters 420) and in determining A-matrix 415. Given the information about the predicted and actual states, another loss function may be determined: L_{pred}=∥xᵢ₊₁−g⁻¹(Ag(x))∥. This equation is similar to the equation for Lₗᵢₙ, except that the loss is computed relative to the original state space rather than the “lifted” state space.

There is another equation that may be used to govern the simulation as a whole. The simulation as a whole may have a total cost function of the form L=α₁ (L_{recon}+L_{pred})+Lₗᵢₙ+α₂L_{∞}+α₃∥W∥₂, where weights α₁, α₂, and α₃ are hyperparameters and W is a weight matrix (including the weights to be applied to the individual nodes as discussed above). During training of neural network encoder 125, weight matrix W may be initialized randomly from a uniform distribution in the range [−s, s] for

$$s = \frac{1}{\sqrt{a}} ,$$

where α is the dimension of the input layer (each bias vector b may also be initialized to 0). Optimizing the simulation as a whole may involve minimizing this total cost function.

At this point, maneuver module 140 of FIG. 1 may be discussed again. By performing a computation as described for a simulation, it is possible to determine a next predicted state Ag(x_{T}). There are a number of ways in which this next predicted state may be used to determine a maneuver. One approach is simply to compare g(x_{T}) and Ag(x_{T}). Based on the current “lifted” state and the next predicted state (in the “lifted” state space), an appropriate maneuver may be determined. Because this approach does not involve using neural network decoder 135, this approach shows that neural network decoder 135 may not be needed to implement all embodiments of the inventive concept. Alternatively, the next predicted state may be “dropped” back into the original state space (that is, by computing g⁻¹(Ag(x_{T}))) and comparing that state with either x_{T} or \tilde{x}_{T}=g⁻¹(Ag(x_{T-1})) (the current actual state and current predicted state, respectively), to determine the appropriate maneuver.

It is also worth pausing at this point to discuss why different sets of input states [x₁, x₂, . . . , x_{T}] may involve different encoding functions g(x) and different A-matrices. The reason involves the use of linear solutions to the least-squares problem. A linear solution attempts to find a straight line that best fits the provided data points. And while a straight line is an elegant solution when the data is expected to be roughly linear, simulations rarely involve data that organizes in straight lines. For example, operating a vehicle involves acceleration, deceleration, changes in orientation, and many other changes in data over time. A straight line does not necessarily provide an elegant solution to such varied data points.

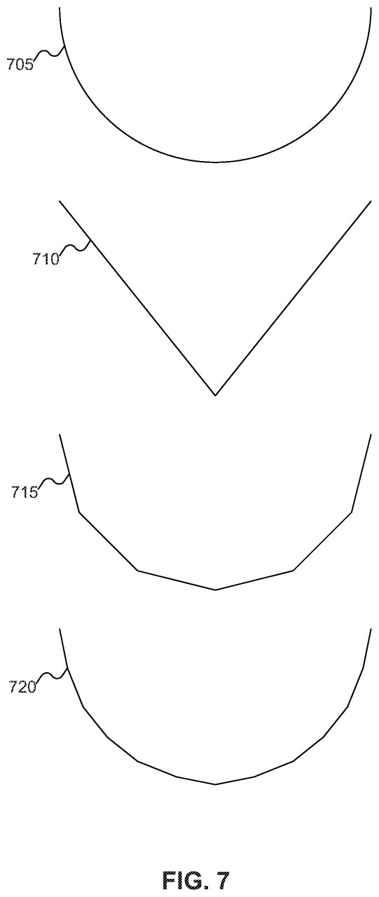

But a straight line often does provide a decent approximation of what is happening over a short interval along a curve, even if the straight line is not accurate over the entire length of the curve. Consider, for example, FIG. 7, which shows curve 705. Curve 705 is a continuous curve that is differentiable over the entire length shown (except for its endpoints). Obviously a single straight line would be a poor approximation of this curve; even the combination of two line segments, shown in approximation 710 is a relatively poor approximation of curve 705. But as the number of line segments increases, the approximation improves: approximation 715 includes six line segments, and already roughly approximates curve 705. Approximation 720, with 12 line segments, already looks very much line curve 705. Clearly, as more line segments are used, the approximation becomes closer and closer to the actual curve. But note that each line segment in approximations 710, 715, and 720 is part of a different line. Put mathematically, a line is defined by the equation y=mx+b, where m is the slope of the line (how much the line goes up or down over a given horizontal length) and b is the x-intercept (where the line intercepts the x-axis of a graph). Each line segment in approximations 710, 715, and 720 is part of a line that uses different values of m and b.

The same is true for using Koopman theory to determine behavior of an agent in a simulation. While a single linear approximation of the overall behavior of the agent would be poor, a linear approximation of the behavior of the agent over a small interval of time should be close enough to the desired curve to suffice. But just like each line segment in FIG. 7 is part of a different line, each interval of time using Koopman theory could be expected to use a different A-matrix and different encoding functions g(x). Thus, as the state history changes over time, the encoding functions g(x) and the A-matrices may be expected to change.

It is worth comparing embodiments of the inventive concept with related to U.S. patent application Ser. No. 16/576,750, filed Sep. 19, 2019, which claims the benefit of U.S. Provisional Patent Application Ser. No. 62/889,033, filed Aug. 19, 2019, both of which are incorporated by reference herein for all purposes. In related to U.S. patent application Ser. No. 16/576,750, filed Sep. 19, 2019, it is expected that different models will provide solutions with varying levels of confidence, which will supplement each other: where one model is weak, another model is expected to be strong. Thus, for example, one model might be well equipped to handle keeping a relative distance from a vehicle in front, whereas another model might be better equipped to handle roundabouts and construction zones.

In contrast, in embodiments of this inventive concept, a single model is expected to be able to process all situations that might be encountered in the simulation: the neural network encoder and the A-matrix. But while the single model in embodiments of the inventive concept may be able to handle a variety of different situations, the computations involved in determining the next state of the simulation may become very complex, potentially regardless of the specific situation being addressed. Thus, by using Koopman theory, computation of the solution is simplified in the single model approach described herein.

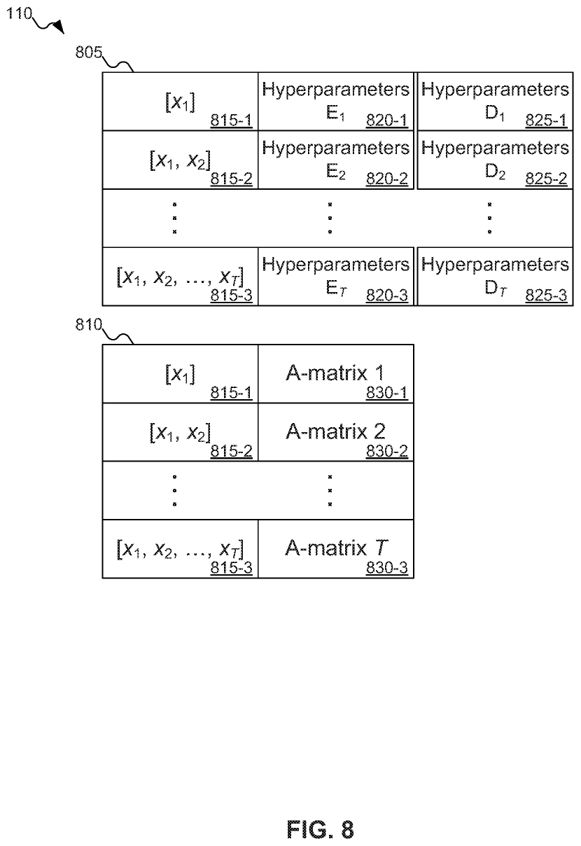

FIG. 8 shows various tables of information stored in memory 110 of FIG. 1. In FIG. 8, memory 110 is shown as including two tables 805 and 810. In table 805, each entry includes a set of states, along with corresponding sets of hyperparameters: one for neural network encoder 125 of FIG. 1 and one for neural network decoder 135 of FIG. 1. (Of course, if neural network decoder 135 of FIG. 1 is not used, then the hyperparameters for neural network decoder 135 of FIG. 1 do not need to be stored in table 805.) Thus, for set of states 815-1, the corresponding hyperparameters for neural network encoder 125 of FIG. 1 are shown as hyperparameters E₁ 820-1 and the corresponding hyperparameters for neural network decoder 135 of FIG. 1 are shown as hyperparameters D₁ 825-1. Similarly, for set of states 815-2, the corresponding hyperparameters for neural network encoder 125 of FIG. 1 are shown as hyperparameters E₂ 820-2 and the corresponding hyperparameters for neural network decoder 135 of FIG. 1 are shown as hyperparameters D₂ 825-2, and for set of states 815-3, the corresponding hyperparameters for neural network encoder 125 of FIG. 1 are shown as hyperparameters E₃ 820-3 and the corresponding hyperparameters for neural network decoder 135 of FIG. 1 are shown as hyperparameters D₃ 825-3. While FIG. 8 shows three rows in table 805, embodiments of the inventive concept may include any number of rows in table 805.

Table 810 may store entries associating sets of states with appropriate A-matrices. Thus, for set of states 815-1 the corresponding A-matrix is A-matrix 1 830-1, for set of states 815-2 the corresponding A-matrix is A-matrix 1 830-2, and for set of states 815-3 the corresponding A-matrix is A-matrix 1 830-3. As with table 805, embodiments of the inventive concept may include any number of rows in table 810.

In addition, FIG. 8 merely presents one way to organize the data shown: embodiments of the inventive concept may organize the data in other ways. For example, as the same sets of states index into both the hyperparameters and the A-matrices, a single table may be used to store all the data. Or, different tables may be used to store hyperparameters for neural network encoder 125 of FIG. 1 and for neural network decoder 135 of FIG. 1.

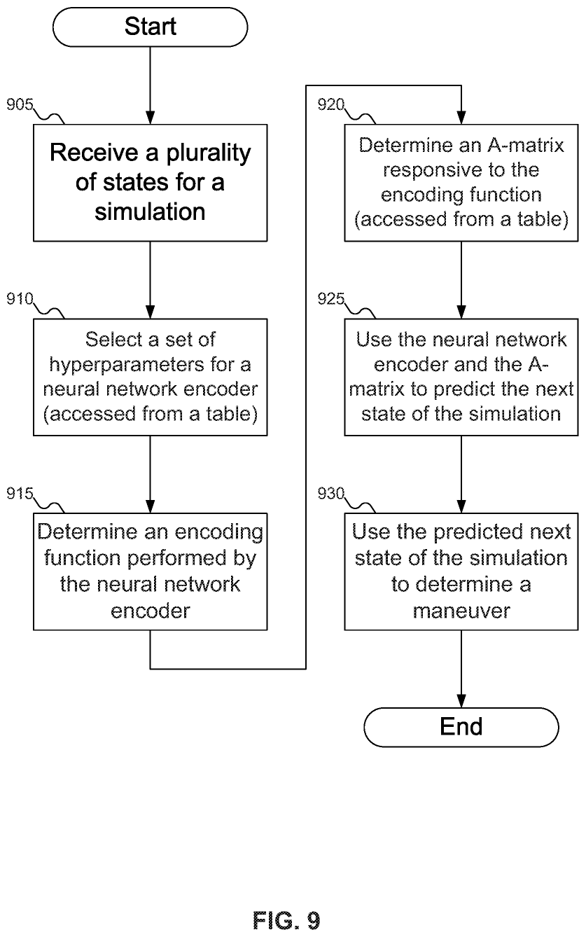

FIG. 9 shows a flowchart of an example procedure to use neural network encoder 125 of FIG. 1 and Koopman theory to simplify the solution to a complex system, according to an embodiment of the inventive concept. In FIG. 9, at block 905, receiver 120 of FIG. 1 may receive states of the simulation. At block 910, using the received states of the simulation, appropriate hyperparameters 410 of FIG. 4 may be selected from table 805 of FIG. 8 of memory 110 of FIG. 1. At block 915, using selected hyperparameters 410 of FIG. 4, neural network encoder 125 of FIG. 1 may be modified to implement a determined encoding function g(x).

At block 920, appropriate A-matrix 415 of FIG. 4 may be determined, responsive to the determined encoding function g(x). At block 925, using the received states of the simulation, the determined encoding function g(x), and A-matrix 415 of FIG. 4, neural network encoder 125 of FIG. 1 and least-squares solver 130 of FIG. 1 may be used to determine the next predicted state \tilde{x}_{T+1} of the simulation. Finally, at block 930, maneuver module 140 of FIG. 1 may use the next predicted state \tilde{x}_{T+1} of the simulation to determine an appropriate maneuver for an agent in the simulation.

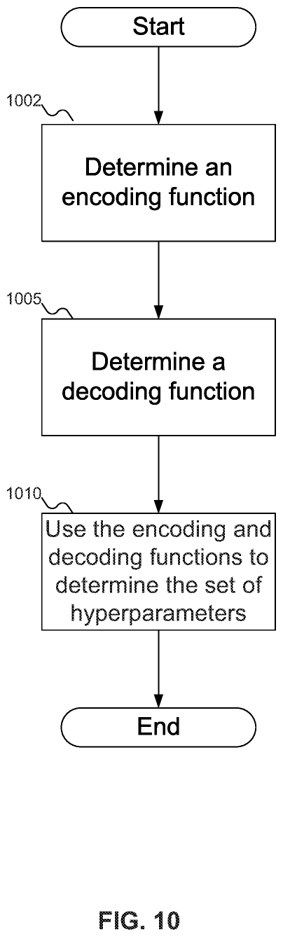

FIG. 10 shows a flowchart of an example procedure to use neural network encoder 125 of FIG. 1 and neural network decoder 135 of FIG. 1 in determining hyperparameters for the neural network encoder of FIG. 1, according to an embodiment of the inventive concept. In FIG. 10, at block 1005, for a given set of states for a simulation as input, an encoding function g(x) may be determined for neural network encoder 125 of FIG. 1. At block 1010, for the same set of states for the simulation, a decoding function g⁻¹(x) may be determined for neural network decoder 135 of FIG. 1. Finally, at block 1015, using the encoding and decoding functions, hyperparameters 410 of FIG. 4 may be determined for neural network encoder 125 of FIG. 1. In addition, hyperparameters 420 of FIG. 4 may be determined for neural network decoder 135 of FIG. 1).

In FIGS. 9-10, some embodiments of the inventive concept are shown. But a person skilled in the art will recognize that other embodiments of the inventive concept are also possible, by changing the order of the blocks, by omitting blocks, or by including links not shown in the drawings. All such variations of the flowcharts are considered to be embodiments of the inventive concept, whether expressly described or not.

Embodiments of the inventive concept offer technical advantages over the prior art. Whereas computation of solutions to non-linear systems may be complex and expensive (assuming it is even possible), by “lifting” the data into a higher state space it may be possible to convolve the problem into a linear system. Since linear systems are generally easier to solve than non-linear systems, the added cost of “lifting” the problem into a higher state space is offset by the simpler computations to solve the problem in the “lifted” state space.

The following discussion is intended to provide a brief, general description of a suitable machine or machines in which certain aspects of the inventive concept may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present inventive concept may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the inventive concept may include a tangible, non-transitory machine-readable medium comprising instructions executable by one or more processors, the instructions comprising instructions to perform the elements of the inventive concepts as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the inventive concept with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the inventive concept” or the like are used herein, these phrases are meant to generally reference embodiment possibilities, and are not intended to limit the inventive concept to particular embodiment configurations. As used herein, these terms may reference the same or different embodiments that are combinable into other embodiments.

The foregoing illustrative embodiments are not to be construed as limiting the inventive concept thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this inventive concept as defined in the claims.

Embodiments of the inventive concept may extend to the following statements, without limitation:

Statement 1. An embodiment of the inventive concept includes a system, comprising:
a receiver to receive a plurality of actual states for a simulation, the plurality of actual states for the simulation including a current actual state for the simulation;
a neural network encoder implemented using at least in part a processor; and
a memory storing a plurality of sets of hyperparameters for the neural network encoder and a plurality of A-matrices,
wherein the system is operative to select a set of hyperparameters from the plurality of sets of hyperparameters and an A-matrix from the plurality of A-matrices responsive to the plurality of actual states for the simulation,
wherein the neural network encoder is operative to use the set of hyperparameters to implement an encoding function, and
wherein the selected A-matrix is used to determine a next predicted state for the simulation responsive to the current actual state for the simulation.

Statement 2. An embodiment of the inventive concept includes the system according to statement 1, wherein the A-matrix is determined by solving a least-squares problem responsive to each state in the plurality of actual states for the simulation and each subsequent state in the plurality of actual states for the simulation.

Statement 3. An embodiment of the inventive concept includes the system according to statement 1, wherein the set of hyperparameters are selected to minimize the difference between the plurality of actual states for the simulation and a encoding and decoding of the plurality of actual states for the simulation using the encoding function.

Statement 4. An embodiment of the inventive concept includes the system according to statement 1, wherein the set of hyperparameters are selected to minimize the difference between a plurality of next predicted states using the A-matrix and the plurality of actual states for the simulation.

Statement 5. An embodiment of the inventive concept includes the system according to statement 4, wherein the set of hyperparameters are selected to further minimize the difference between the next predicted state for the simulation and a next actual state for the simulation.

Statement 6. An embodiment of the inventive concept includes the system according to statement 1, wherein the memory includes a first table storing the plurality of sets of hyperparameters.

Statement 7. An embodiment of the inventive concept includes the system according to statement 6, wherein the memory further includes a second table storing a plurality of A-matrices.

Statement 8. An embodiment of the inventive concept includes the system according to statement 1, further comprising a neural network decoder implemented using at least in part the processor, the neural network decoder is operative to use the set of hyperparameters to implement a decoding function.

Statement 9. An embodiment of the inventive concept includes the system according to statement 8, wherein the decoding function performed using the neural network decoder is used to determine the set of hyperparameters for the neural network during training.

Statement 10. An embodiment of the inventive concept includes the system according to statement 1, wherein the simulation includes one of an autonomous vehicle simulation and a dynamic agent in a vehicle simulation.

Statement 11. An embodiment of the inventive concept includes the system according to statement 10, further comprising a maneuver module to determine a maneuver for the autonomous vehicle simulation or the dynamic agent in the vehicle simulation responsive to the next predicted state for the simulation.

Statement 12. An embodiment of the inventive concept includes a method, comprising:
receiving a plurality of actual states for a simulation, the plurality of actual states for the simulation including a current actual state for the simulation;
selecting a set of hyperparameters for a neural network encoder responsive to the plurality of actual states for the simulation;
determining an encoding function performed using the neural network encoder responsive to the set of hyperparameters for the neural network encoder;
determining an A-matrix, the A-matrix responsive to the encoding function performed using the neural network encoder; and
using the neural network encoder and the A-matrix to determine a next predicted state for the simulation responsive to the current actual state for the simulation.

Statement 13. An embodiment of the inventive concept includes the method according to statement 12, wherein the A-matrix is determined by solving a least-squares problem responsive to each state in the plurality of actual states for the simulation and each subsequent state in the plurality of actual states for the simulation.

Statement 14. An embodiment of the inventive concept includes the method according to statement 12, wherein the set of hyperparameters are selected to minimize the difference between the plurality of actual states for the simulation and a decoding and encoding of the plurality of actual states for the simulation using the encoding function.

Statement 15. An embodiment of the inventive concept includes the method according to statement 12, wherein the set of hyperparameters are selected to minimize the difference between a plurality of next predicted states using the A-matrix and the plurality of actual states for the simulation.

Statement 16. An embodiment of the inventive concept includes the method according to statement 15, wherein the set of hyperparameters are selected to further minimize the difference between the next predicted state for the simulation and a next actual state for the simulation.

Statement 17. An embodiment of the inventive concept includes the method according to statement 12, wherein selecting a set of hyperparameters for a neural network encoder responsive to the plurality of actual states for the simulation included accessing the set of hyperparameters from a table storing a plurality of sets of hyperparameters.

Statement 18. An embodiment of the inventive concept includes the method according to statement 17, wherein determining an A-matrix includes accessing the A-matrix from a plurality of A-matrices stored in a second table.

Statement 19. An embodiment of the inventive concept includes the method according to statement 12, further comprising determining a decoding function performed using a neural network decoder responsive to the set of hyperparameters for the neural network.

Statement 20. An embodiment of the inventive concept includes the method according to statement 19, further comprising using the decoding function performed using the neural network decoder to determine the set of hyperparameters for the neural network during training.

Statement 21. An embodiment of the inventive concept includes the method according to statement 12, wherein the simulation includes one of an autonomous vehicle simulation and a dynamic agent in a vehicle simulation.

Statement 22. An embodiment of the inventive concept includes the method according to statement 21, further comprising using the next predicted state for the simulation to determine a maneuver for the autonomous vehicle simulation or the dynamic agent in the vehicle simulation.

Statement 23. An embodiment of the inventive concept includes an article, comprising a non-transitory storage medium, the non-transitory storage medium having stored thereon instructions that, when executed by a machine, result in:
receiving a plurality of actual states for a simulation, the plurality of actual states for the simulation including a current actual state for the simulation;
selecting a set of hyperparameters for a neural network encoder responsive to the plurality of actual states for the simulation;
determining an encoding function performed using the neural network encoder responsive to the set of hyperparameters for the neural network encoder;
determining an A-matrix, the A-matrix responsive to the encoding function performed using the neural network encoder; and
using the neural network encoder and the A-matrix to determine a next predicted state for the simulation responsive to the current actual state for the simulation.

Statement 24. An embodiment of the inventive concept includes the article according to statement 23, wherein the A-matrix is determined by solving a least-squares problem responsive to each state in the plurality of actual states for the simulation and each subsequent state in the plurality of actual states for the simulation.

Statement 25. An embodiment of the inventive concept includes the article according to statement 23, wherein the set of hyperparameters are selected to minimize the difference between the plurality of actual states for the simulation and a decoding and encoding of the plurality of actual states for the simulation using the encoding function.

Statement 26. An embodiment of the inventive concept includes the article according to statement 23, wherein the set of hyperparameters are selected to minimize the difference between a plurality of next predicted states using the A-matrix and the plurality of actual states for the simulation.

Statement 27. An embodiment of the inventive concept includes the article according to statement 26, wherein the set of hyperparameters are selected to further minimize the difference between the next predicted state for the simulation and a next actual state for the simulation.

Statement 28. An embodiment of the inventive concept includes the article according to statement 23, wherein selecting a set of hyperparameters for a neural network encoder responsive to the plurality of actual states for the simulation included accessing the set of hyperparameters from a table storing a plurality of sets of hyperparameters.

Statement 29. An embodiment of the inventive concept includes the article according to statement 28, wherein determining an A-matrix includes accessing the A-matrix from a plurality of A-matrices stored in a second table.

Statement 30. An embodiment of the inventive concept includes the article according to statement 23, the non-transitory storage medium having stored thereon further instructions that, when executed by the machine, result in determining a decoding function performed using a neural network decoder responsive to the set of hyperparameters for the neural network.

Statement 31. An embodiment of the inventive concept includes the article according to statement 30, the non-transitory storage medium having stored thereon further instructions that, when executed by the machine, result in using the decoding function performed using the neural network decoder to determine the set of hyperparameters for the neural network during training.

Statement 32. An embodiment of the inventive concept includes the article according to statement 23, wherein the simulation includes one of an autonomous vehicle simulation and a dynamic agent in a vehicle simulation.

Statement 33. An embodiment of the inventive concept includes the article according to statement 32, the non-transitory storage medium having stored thereon further instructions that, when executed by the machine, result in using the next predicted state for the simulation to determine a maneuver for the autonomous vehicle simulation or the dynamic agent in the vehicle simulation.

Consequently, in view of the wide variety of permutations to the embodiments described herein, this detailed description and accompanying material is intended to be illustrative only, and should not be taken as limiting the scope of the inventive concept. What is claimed as the inventive concept, therefore, is all such modifications as may come within the scope and spirit of the following claims and equivalents thereto.

What is claimed is:

1. A system, comprising:
a receiver to receive a plurality of actual states for a simulation, the plurality of actual states for the simulation including a current actual state for the simulation;
a neural network encoder implemented using at least in part a processor; and
a memory storing a plurality of sets of hyperparameters for the neural network encoder and a plurality of A-matrices,
wherein the system is operative to select a set of hyperparameters from the plurality of sets of hyperparameters and an A-matrix from the plurality of A-matrices responsive to the plurality of actual states for the simulation,
wherein the neural network encoder is operative to use the set of hyperparameters to implement an encoding function, and
wherein the selected A-matrix is used to determine a next predicted state for the simulation responsive to the current actual state for the simulation.

2. The system according to claim 1, wherein the A-matrix is determined by solving a least-squares problem responsive to each state in the plurality of actual states for the simulation and each subsequent state in the plurality of actual states for the simulation.

3. The system according to claim 1, wherein the set of hyperparameters are selected to minimize the difference between the plurality of actual states for the simulation and a encoding and decoding of the plurality of actual states for the simulation using the encoding function.

4. The system according to claim 1, wherein the set of hyperparameters are selected to minimize the difference between a plurality of next predicted states using the A-matrix and the plurality of actual states for the simulation.

5. The system according to claim 4, wherein the set of hyperparameters are selected to further minimize the difference between the next predicted state for the simulation and a next actual state for the simulation.

6. The system according to claim 1, further comprising a neural network decoder implemented using at least in part the processor, the neural network decoder is operative to use the set of hyperparameters to implement a decoding function.

7. The system according to claim 6, wherein the decoding function performed using the neural network decoder is used to determine the set of hyperparameters for the neural network during training.

8. The system according to claim 1, wherein the simulation includes one of an autonomous vehicle simulation and a dynamic agent in a vehicle simulation.

9. The system according to claim 8, further comprising a maneuver module to determine a maneuver for the autonomous vehicle simulation or the dynamic agent in the vehicle simulation responsive to the next predicted state for the simulation.

10. A method, comprising:
receiving a plurality of actual states for a simulation, the plurality of actual states for the simulation including a current actual state for the simulation;
selecting a set of hyperparameters for a neural network encoder responsive to the plurality of actual states for the simulation;
determining an encoding function performed using the neural network encoder responsive to the set of hyperparameters for the neural network encoder;
determining an A-matrix, the A-matrix responsive to the encoding function performed using the neural network encoder; and
using the neural network encoder and the A-matrix to determine a next predicted state for the simulation responsive to the current actual state for the simulation.

11. The method according to claim 10, wherein the A-matrix is determined by solving a least-squares problem responsive to each state in the plurality of actual states for the simulation and each subsequent state in the plurality of actual states for the simulation.

12. The method according to claim 10, wherein the set of hyperparameters are selected to minimize the difference between the plurality of actual states for the simulation and a decoding and encoding of the plurality of actual states for the simulation using the encoding function.

13. The method according to claim 10, wherein the set of hyperparameters are selected to minimize the difference between a plurality of next predicted states using the A-matrix and the plurality of actual states for the simulation.

14. The method according to claim 13, wherein the set of hyperparameters are selected to further minimize the difference between the next predicted state for the simulation and a next actual state for the simulation.

15. The method according to claim 10, further comprising determining a decoding function performed using a neural network decoder responsive to the set of hyperparameters for the neural network.

16. The method according to claim 15, further comprising using the decoding function performed using the neural network decoder to determine the set of hyperparameters for the neural network during training.

17. The method according to claim 10, wherein the simulation includes one of an autonomous vehicle simulation and a dynamic agent in a vehicle simulation.

18. The method according to claim 17, further comprising using the next predicted state for the simulation to determine a maneuver for the autonomous vehicle simulation or the dynamic agent in the vehicle simulation.

19. An article, comprising a non-transitory storage medium, the non-transitory storage medium having stored thereon instructions that, when executed by a machine, result in:
receiving a plurality of actual states for a simulation, the plurality of actual states for the simulation including a current actual state for the simulation;
selecting a set of hyperparameters for a neural network encoder responsive to the plurality of actual states for the simulation;
determining an encoding function performed using the neural network encoder responsive to the set of hyperparameters for the neural network encoder;
determining an A-matrix, the A-matrix responsive to the encoding function performed using the neural network encoder; and
using the neural network encoder and the A-matrix to determine a next predicted state for the simulation responsive to the current actual state for the simulation.

20. The article according to claim 19, wherein the A-matrix is determined by solving a least-squares problem responsive to each state in the plurality of actual states for the simulation and each subsequent state in the plurality of actual states for the simulation.
